(19) United States
(12) Patent Application Publication
(10) Pub. No.: US 2021/0256504 A1
(43) Pub. Date: Aug. 19, 2021

(54) System, Device and Method for Executing a Digital Wallet Application

(71) Applicant: IMAGENPAY UK LIMITED, Cheshire (GB)

(72) Inventors: Michael Donald, Cheshire (GB); Alexander Donald, Cheshire (GB)

(21) Appl. No.: 17/056,323

(22) PCT Filed: May 20, 2019
(86) PCT No.: PCT/EP2019/063007

§ 371 Date: Nov. 17, 2020

(30) Foreign Application Priority Data
May 18, 2018 (GB) 1808114.1
Nov. 30, 2018 (GB) 1819590.9

(51) Int. Cl. G06Q 20/36; G06Q 20/34; G06Q 20/32

(52) U.S. Cl. CPC G06Q 20/363; G06Q 20/325; G06Q 20/3672; G06Q 20/355

(57) ABSTRACT

The system comprises a user electronic device (200). A processor of the device (200) executes a digital wallet application associated with at least one digitised transaction card. The device (200) obtains user preference information in relation to the digital wallet application (S604); communicates the user preference information to a management server (300, S605); receives, from the management server (300), a notification command for the digital wallet application (S614). The notification command is determined according to the user preference information, and determines the audible and/or haptic feedback to be provided in relation to the digitised transaction card. The user electronic device (200) controls an audio and/or haptic output unit of the device to provide, when the digital wallet application is executed, audible and/or haptic feedback according to the notification command in response to the digitised transaction card being selected and/or used for a transaction.

The present invention relates to a system, device and method for executing a digital wallet application. In particular, the present invention relates to a system, device and method for providing audible and/or haptic feedback when a digital wallet application is executed.

It is common for consumers to utilise a digital wallet application running on a user electronic device to perform electronic transactions. For example, digital wallet applications may be used to transfer money for the payment of goods or services. The user electronic device is typically a mobile user device, in particular a mobile telecommunications device, such as a smartphone for example. The user electronic device will generally employ near-field communication (NFC) or a similar short-range communication protocol communication to enable a swift, contactless, transaction to be performed.

To be able to perform electronic transactions using a digital wallet application, a user, is typically required to upload information relating to their physical transaction cards (e.g. payment cards such as credit and debit cards, and loyalty cards) to a digital wallet payment system using the digital wallet application operating on the user electronic device. Known digital wallet payment applications and systems include Apple Pay®, Google Pay®, and Samsung Pay®. This information can be uploaded to the digital wallet application using a camera of the user electronic device, by manually entering the card details into the user electronic device or by importing the data from a separate application. A benefit of digitised wallet applications is that a user is not required to carry around a bulky physical wallet containing their physical transaction cards. Instead, the user may upload each of their cards to the digital wallet application so that only their user electronic device is required to perform transactions. This not only saves the user the hassle of carrying around many different cards for different purposes, but also removes the possibility of losing cards or having cards stolen.

Typically, in the digital wallet application, the digitised transaction card is represented by an image. A plurality of images each representing a different digitised transaction card registered in the digital wallet application may be displayed in list form. One of the registered digitised transaction cards may be selected by the user as a default digitised transaction card.

When a user makes a transaction via NFC using the user electronic device, the default digitised transaction card is used for payment. At the Point of Sale (PoS), the user presents the device to a payment terminal with NFC enabled, and receives a standard confirmatory audio or vibration notification from the user electronic device when the transaction has been completed. Such notification is provided so that the user knows that the wireless interaction with the PoS terminal and the user electronic device has completed successfully. The user can then remove the user electronic device from the NFC reader knowing that the interaction has completed.

In current implementations of digital wallet applications, if a user wishes to access information relating to their transactions, this is only possible once they have accessed the digital wallet application on their user electronic device, requested information regarding recent transactions and then found the applicable transactions. This is particularly time-consuming and problematic, especially given that the main advantage of digital wallet applications is their speed and convenience.

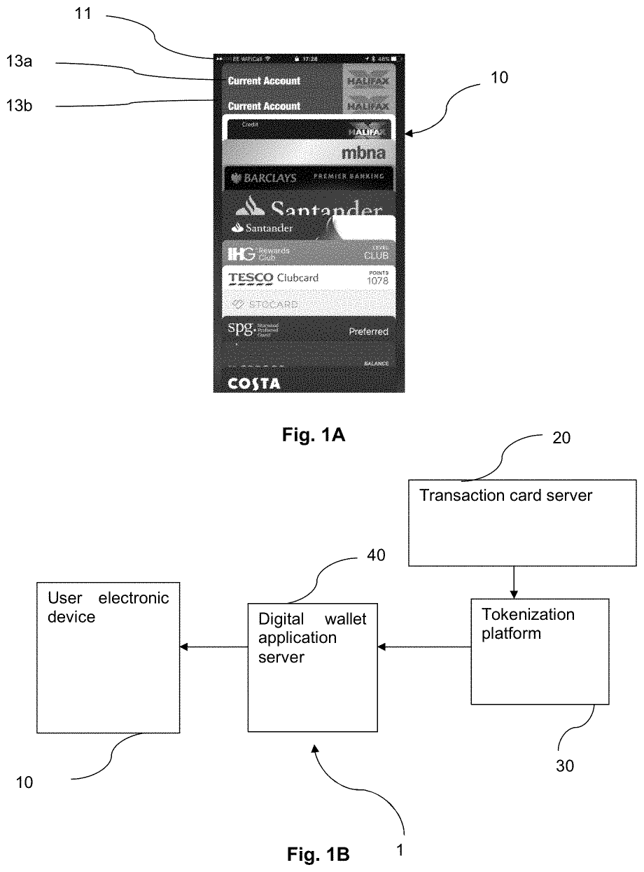

FIG. 1A shows an example existing digital wallet application 11 which is displayed running on a user electronic device 10. The digital wallet application 11 displays a number of digitised transaction cards 13a, 13b. FIG. 1B shows an example digital wallet application system architecture 1. The system 1 comprises a user electronic device 10, a transaction card server 20, a tokenization platform 30 and a digital wallet application server 40. The transaction card server 20 is operated by an entity that provides the digitised transaction card, e.g. a payment services provided or PSP. In some examples, this entity may be a bank that issues the digitised transaction card. The tokenization platform 30 may be part of the transaction card server 20 or may be provided by a separate entity, The digital wallet application management server 20 may be operated by an entity that provides the digital wallet application on the user electronic device 10.

According to the present invention there is provided an apparatus and method as set forth in the appended claims. Other features of the invention will be apparent from the dependent claims, and the description which follows.

According to an aspect of the invention, there is provided a system. The system comprises a user electronic device comprising a communicator, an audio and/or haptic output unit, and a processor communicatively coupled to the communicator and the audio and/or haptic output unit. The processor is operable to execute a digital wallet application. The digital wallet application is associated with at least one digitised transaction card. The processor of the user electronic device is operable to: obtain user preference information in relation to the digital wallet application; control the communicator to communicate the user preference information to a management server; control the communicator to receive, from the management server, a notification command, the notification command being determined according to the user preference information, and the notification command determining the audible and/or haptic feedback to be provided in relation to the digitised transaction card. The processor of the user electronic device is further operable to control the audio and/or haptic output unit to provide, when the digital wallet application is executed, audible and/or haptic feedback according to the notification command received from the management server in response to the digitised transaction card being selected and/or a transaction being performed using the digitised transaction card.

Here, the audio and/or haptic output unit refers to a unit of the user electronic device that can provide only an audible output, only a haptic output, or both an audible output and a haptic output, The audio and/or haptic output unit may comprise two separate components of the user electronic device. That is an audio output unit and a separate haptic output unit may be provided in the user electronic device. The audible feedback will be understood as meaning a sound output. The audible feedback may be output directly by the user electronic device or may be output via a speaker device in communication with the user electronic device and configured to receive an audio signal from the user electronic device. The speaker device may be a loudspeaker or headphones/earphones, The haptic feedback refers to a mechanical output that can be sensed by the user's touch. The haptic output may include forces, vibrations and/or motions. In most examples, the haptic output will be a vibration output. The audible and/or haptic feedback acts as a notification to the user.

Here, ‘digitised transaction card’ may refer to a digitised representation of a physical transaction card. The transaction card may be a transaction card such as a debit or credit transaction card, a loyalty card, or a pre-paid transaction card.

Significantly, the user electronic device of the present invention communicates user preference information to a management server. The management server uses the user preference information to determine and communicate a notification command to the user electronic device. The notification command determines the audible and/or haptic feedback to be provided in relation to the digitised transaction card. This means that, when the digital wallet application is executed, the user electronic device provides audible and/or haptic feedback according to the notification command in response to the digitised transaction card being selected and/or a transaction being performed using the digitised transaction card.

Advantageously, the audible and/or haptic feedback provided in relation to the digitised transaction card is determined according to user preference information. This means that the audible and/or haptic feedback is user specific feedback. This is important because the audible and/or haptic feedback may be generated in a public environment such as at a Point-of-Sale (PoS). If the feedback was not provided according to user preference information, then the feedback may be readily understandable to other people in the vicinity of the user, i.e. because the feedback would be general rather than user specific. For example, an audible notification in the form of a person speaking and providing information would be easily understood to other people and could potentially result in sensitive information being presented to the public. The present invention, however, determines the audible and/or haptic feedback according to user preference information. In examples of the present invention, this effectively results in the feedback conveying encoded information that is only understandable to the user of the user electronic device. The feedback may convey encoded information by using a particular frequency, or change in frequency over time, amplitude, or change in amplitude over time, or duration of the feedback, to convey particular information to the user. This information will be ascertainable to the user because the user has set the parameters such as the frequency, amplitude and duration of the signal according to their user preference information. In other words, the present invention effectively creates an audible and/or haptic feedback which has a known meaning to the user, as it is in a form predetermined or known to the user, but does not have a known meaning to other people besides the user. The present invention thus securely provides information relating to a digitised transaction card to the user over an unsecured, public, communication channel, i.e. in the form of audible and/or haptic feedback.

The present invention is not limited to a user selecting a particular time, amplitude or frequency of the signal to convey encoded information. Instead, the user could for example select a particular song or excerpt of a song to convey desired information. Since only the user would know about the relationship between the song and the information it is associated with, the song can be used to provide information to the user in a secure manner.

This present invention is not limited to transactions performed via NFC at a PoS. Audible and/or haptic feedback in accordance with the present invention may also be generated for transactions performed online such as by a user navigating to a webpage to perform a transaction.

Moreover, the provision of the management server is significant as it effectively integrates into existing legacy system architectures executing digital wallet applications running on user electronic devices, without requiring a complete re-design of the existing system architectures such as existing transaction card servers and tokenization platforms, which may not be practical or plausible. The management server thus provides an efficient retro-fitting solution. Moreover, the management server is able to control how the notification commands associated with digitised transaction cards are determined provided to the user electronic device. This may be beneficial in ensuring user compliance with the digital wallet system architecture.

The digital wallet application may be associated with a plurality of digitised transaction cards. Notification commands may be received for each of the digitised transaction cards according to the user preference information. Different audible and/or haptic feedback may be provided depending on which digitised transaction card is selected and/or used to perform a transaction.

The processor of the user electronic device may be operable to: obtain user preference information in relation to each of the plurality of digitised transaction cards in the digital wallet application. The processor of the user electronic device may be operable to control the communicator to communicate the user preference information to a management server.

The processor of the user electronic device may be operable to control the communicator to receive, from the management server, a notification command for each of the plurality of digitised transaction cards in the digital wallet application. Each of the notification commands may be determined according to the user preference information associated with the corresponding digitised transaction card. The notification command may determine the audible and/or haptic feedback to be provided in relation to the corresponding digitised transaction card. The processor of the user electronic device may be operable to control the audio and/or haptic output unit to provide, when the digital wallet application is executed, audible and/or haptic feedback according to the notification command received from the management server in response to the digitised transaction card being selected and/or a transaction being performed using the digitised transaction card.

Advantageously, each of the digitised transaction cards in the digital wallet application is able to be associated with a different notification command which is in turn determined according to user preference information. This means that the audible and/or haptic feedback provided may be specific to the particular digitised transaction card selected in the digital wallet application or used in a transaction.

The digital wallet application, when executed, may be arranged to display a plurality of graphic assets each associated with a different one of the digitised transaction cards. In response to one of the digitised transaction cards being selected by the user, the processor of the user electronic device may be operable to control the audio and/or haptic output unit to provide audible and/or haptic feedback according to the notification command associated with the selected digitised transaction card.

Advantageously, different digitised transaction cards selected in the digital wallet application will generate different audible and/or haptic feedback. This feedback is determined according to the notification command received from the management server. As such, the user is able to easily identify the digitised transaction cards based on the different audible and/or haptic feedback provided when the individual digitised transaction cards are selected in the digital wallet application. This is beneficial particularly for people with visual impairment who may not be able to identify the digitised transaction cards based on the images displayed in the digital wallet application. This is also beneficial when multiple digitised transaction cards all have the same image. This problem occurs when a user has multiple different digitised transaction cards issued from the same bank. In existing digital wallet applications, images to be displayed in the digital wallet are provided based on the bank identification number (BIN), and so all digitised transaction cards from the same provider will have the same image. An example of this is shown in FIG. 1A where the digital wallet application contains two different digitised transaction cards 13a, 13b with the same displayed image. The use of audible and/or haptic feedback will enable these two digitised transaction cards 13a, 13b to be distinguished from one another even though their images are the same.

The audio and/or haptic output unit may comprise a vibration unit configured to vibrate the user electronic device. At least one of the frequency, amplitude and duration of the vibration may be determined by the notification command.

The audio and/or haptic output unit may comprise an audio output module such as a speaker configured to output an audible signal. At least one of the frequency, amplitude and duration of the audible signal may be determined by the notification command.

The audible and/or haptic feedback may be configurable to have different meanings such that the user can change the feedback so that is has a particular desired meaning. In this way, the present invention advantageously increases the entropy of the communication between the user electronic device and the user by providing more information specific to the interaction which has just occurred between the user electronic device and any external device, such as an NFC reader or a merchant server that facilitates online transactions. This can be achieved in some embodiments without increasing the duration of the communication. For example, for audible feedback, different audible sounds (having the same duration of typically 0.5 seconds) for example may have different meanings. The pitch (or frequency) can be changed as can the composition of the frequencies used for the feedback notification. In some examples, it is preferable for the amplitude (volume) of the audible feedback remains constant for notifications having different meanings. This ensures, advantageously, that users with poor hearing can be assured to hear all of the composition of the feedback notification in dependence upon the local audio volume level setup of their electronic device. Similarly, the duration of the feedback notification is, in some examples, preferably constant in order to enable the user to recognise that the feedback notification relates to feedback of the transaction rather than any other sound which may emanate from the user electronic device. For example, if a smart phone is being used and a text message or email is received at the same time as a user interaction with an NFC device or a merchant server facilitating an online transaction is happening, the text/email notification will typically have a different duration in time to the audible notification generated in response to the interaction of the smartphone with the NFC reader or the merchant server. It may also have a different composition, but the duration difference can help to distinguish a class of notifications belonging to the feedback of current interaction with external devices as opposed to a class of notification messages relating to information being pushed to the smartphone.

The audible and/or haptic feedback provided according to the notification command may change based on at least one of: the digitised transaction card; the status of the transaction; the value of the transaction; the cumulative value of transactions made during a predetermined time period; the number of transactions made during a predetermined time period; the frequency of transactions made within a predetermined time period; and whether the digitised transaction card is associated with a loyalty scheme.

The audible and/or haptic feedback changing based on the digitised transaction card may mean that different digitised transaction cards are associated with different audible and/or haptic feedback. This provides the benefit of enabling easier identification of the different digitised transaction cards in the digital wallet application as discussed above.

The audible and/or haptic feedback changing based on the status of the transaction may mean that different audible and/or haptic feedback is provided based on whether the transaction is pending, approved, or rejected. This provides the benefit of enabling the user to easily identify whether the transaction was successful.

The audible and/or haptic feedback changing based on the value of the transaction may mean that different audible and/or haptic feedback is provided based on the value of the transaction. For example, the frequency of the audible feedback may change from a low frequency to a high frequency as the value of the transaction increases. For example, the amplitude of the haptic feedback may change from a low amplitude to a high amplitude as the value of the transaction increases. Of course, other arrangements are possible and the particular audible and/or haptic feedback to be provided is determined based on the user preference information.

Beneficially, the user can select how the feedback is to be provided for different values of transaction. This can enable the user to easily identify the value of the transaction, and provides a simple mechanism for a user to check whether the transaction was of a different value than expected. In addition, the feedback can serve as a warning to the user to dissuade them from undertaking additional high-value transactions.

The audible and/or haptic feedback changing based on the cumulative value of transactions made during a predetermined time period may mean that the feedback changes as the cumulative value of the transactions increases within the predetermined time period. This provides the benefit of enabling the user to easily control the use of their digital wallet application and control expenditure. The user can set limits to the value of transactions made within a predetermined time period (e.g. 1 day, a week, or a month) and use the audible and/or haptic feedback to control their transactions and manage their finances. The feedback may change based only on transactions made using a particular digitised transaction card, or the feedback may change based on transactions made by all or a subset of the digitised transaction cards in the digital wallet application.

The audible and/or haptic feedback changing based on the number of transactions made during a predetermined time period may mean that the feedback changes as the number of transactions increases within the predetermined time period. This provides the benefit of enabling the user to easily control the use of their digital wallet application and control expenditure. The user can set limits to the number of transactions made within a predetermined time period (e.g. 1 day, a week, or a month) and use the audible and/or haptic feedback to control their transactions and manage their finances. The feedback may change based only on transactions made using a particular digitised transaction card, or the feedback may change based on transactions made by all or a subset of the digitised transaction cards in the digital wallet application.

The audible and/or haptic feedback changing based on the frequency of transactions made within a predetermined time period may mean that the feedback changes as the frequency of transactions increases within the predetermined time period. This provides the benefit of enabling the user to easily control the use of their digital wallet application and control expenditure. The user can set limits to the frequency of transactions made within a predetermined time period (e.g. 1 day, a week, or a month) and use the audible and/or haptic feedback to control their transactions and manage their finances. The feedback may change based only on transactions made using a particular digitised transaction card, or the feedback may change based on transactions made by all or a subset of the digitised transaction cards in the digital wallet application. Here, frequency will be understood has relating to how frequently/rapidly the user is using the digitised transaction card or cards. Making a number of transactions within a short time period will be understood as meaning that the frequency of transactions is increased.

The audible and/or haptic feedback changing based on whether the digitised transaction card is associated with a loyalty scheme may mean that the feedback changes depending on whether the digitised transaction card is used in a transaction associated with a loyalty scheme. For example, the digitised transaction card may be associated with a loyalty scheme for a particular merchant. When the digitised transaction card is used in performing a transaction with the merchant, different audible and/or haptic feedback may be provided so that the use can easily identify that they are obtaining the benefits of the loyalty scheme.

The audible and/or haptic feedback provided according to the notification command may change based on whether a predetermined threshold value has been exceeded in relation to at least one of: the cumulative value of transactions; the number of transactions; and the frequency of transactions.

The user electronic device may be operable to control the communicator to communicate transaction information to a transaction card server in response to a transaction being performed by the digitised transaction card associated with the digital wallet application. The transaction card server may be arranged to authorise the transaction in response to receiving the transaction information. The transaction card server may be or may comprise a payment processor server. The transaction information may be communicated indirectly to the transaction card server via an intermediary. For example, the transaction information may be communicated to the transaction card server may be a merchant server that is performing the transaction with the user of the user electronic device.

The management server may be provided by a separate entity to the entity that provides the transaction card server.

The transaction card server may be arranged to communicate an authorisation response to the management server. The authorisation response may identify at least the digitised transaction card that performed the transaction. The management server may be arranged to communicate the notification command to the user electronic device based on the authorisation response received from the transaction card server and the user preference information received from the user electronic device. The notification command may additionally be determined according to the authorisation response. The authorisation response may indicate whether the transaction was successful, and/or the amount of the transaction, and/or the merchant associated with the transaction. This information may be used along with the user preference information to determine the notification command.

The notification command may comprise an audio file and/or haptic file. The processor of the user electronic device may be operable to store the audio file and/or haptic file in a memory of the user electronic device for subsequent use by the audio and/or haptic output unit. Audio and/or haptic feedbacks may be pre-stored as files on the user electronic device, and when a particular notification command is received from the management server, the processor of the user electronic device may obtain the required file to generate the feedback according to the notification command.

The processor of the user electronic device may be operable to control the communicator to communicate the user preference information to the management server and an identifier for the digitised transaction card associated with the user preference information. The identifier may be a Primary Account Number (PAN) ID.

The user preference information may be determined according to a user input received via a user interface of the user electronic device. The user input may be a touch or voice input.

The processor of the user electronic device may be operable to control the user interface to display an interface for selecting a user preference option. In response to receiving a selection of the user preference option from the user, the processor of the user electronic device may be operable to control the communicator to communicate user preference information associated with the user preference option to the management server.

The processor of the user electronic device may be operable to execute a consumer application for allowing the user to select and change the user preference information associated with the digitised transaction cards. The consumer application may be separate to the digital wallet application.

The consumer application, when executed by the processor of the user electronic device, may be arranged to display on the user interface of the user electronic device at least one of: a registration interface for receiving registration information from a user; an interface of digitised transaction card entries; and a preferences interface for allowing a user to select user preference information. The consumer application may comprise digitised transaction card identification software for identifying the digitised transaction cards of the digital wallet application. The consumer application may comprise or be associated with a library of available user preference options for digitised transaction cards in the digital wallet application.

The consumer application may be downloaded. The application may be sourced from an application store and/or content provider. The content provider may comprise a cloud computing provider.

The consumer application, when executed by the processor of the user electronic device, may operate the digitised transaction card identification software to identify the digitised transaction cards of the digital wallet application. The consumer application may separately or additionally identify user preference information for the digitised transaction cards.

The system may further comprise the management server. The management server may comprise a communicator in communication with the communicator of the user electronic device, and a processor communicatively coupled to the communicator. The processor of the management server may be operable to control the communicator to receive the user preference information from the user electronic device. The processor of the management server may be operable to determine a notification command according to the received user preference information. The processor of the management server may be operable to control the communicator to communicate the notification command to the user electronic device.

The system may further comprise the transaction card server.

According to an aspect of the present invention there is provided a method performed by a system. The system comprising a user electronic device comprising a communicator, an audio and/or haptic output unit, and a processor communicatively coupled to the communicator and the audio and/or haptic output unit. The processor is operable to execute a digital wallet application. The digital wallet application is associated with at least one digitised transaction card. The method comprises obtaining user preference information in relation to the digital wallet application. The method comprises controlling the communicator to communicate the user preference information to a management server. The method comprises controlling the communicator to receive, from the management server, a notification command, the notification command being determined according to the user preference information, and the notification command determining the audible and/or haptic feedback to be provided in relation to the digitised transaction card. The method comprises controlling the audio and/or haptic output unit to provide, when the digital wallet application is executed, audible and/or haptic feedback according to the notification command received from the management server in response to the digitised transaction card being selected and/or a transaction being performed using the digitised transaction card.

According to an aspect of the present invention, there is provided a user electronic device suitable for use with the system according to aspects of the present invention. The user electronic device comprises a communicator, an audio and/or haptic output unit, and a processor communicatively coupled to the communicator and the audio and/or haptic output unit. The processor is operable to execute a digital wallet application. The digital wallet application is associated with at least one digitised transaction card. The processor of the user electronic device is operable to: obtain user preference information in relation to the digital wallet application; control the communicator to communicate the user preference information to a management server; control the communicator to receive, from the management server, a notification command, the notification command being determined according to the user preference information, and the notification command determining the audible and/or haptic feedback to be provided in relation to the digitised transaction card. The processor of the user electronic device is further operable to control the audio and/or haptic output unit to provide, when the digital wallet application is executed, audible and/or haptic feedback according to the notification command received from the management server in response to the digitised transaction card being selected and/or a transaction being performed using the digitised transaction card.

According to the present invention, there is provided a management server for use with the system according to aspects of the present invention. The management server comprises a communicator and a processor communicatively coupled to the communicator. The communicator of the management server is operable to receive user preference information from a user electronic device. The processor of the management server is operable to determine a notification command according to the received user preference information. The notification command determines the audible and/or haptic feedback to be provided in relation to a digitised transaction card associated with the digital wallet application. The processor of the management server is further operable to communicate the notification command to the user electronic so that the user electronic device is operable to provide audible and/or haptic feedback according to the notification command.

The communicator of the management server may be operable to receive an authorisation response from a transaction card server. The authorisation response may identify at least the digitised transaction card of the digital wallet application that performed the transaction. The communicator of the management server may be arranged to communicate the notification command to the user electronic device based on the authorisation response received from the transaction card server and the user preference information received from the user electronic device.

According to another aspect of the present invention, there is provided a system for managing transaction metadata, audio data and notification preferences applied to transactions carried out using a digital wallet. The system may comprise an electronic device, e.g. a user electronic device such as a mobile telecommunications device, which is associated with an end user. The end user may be a consumer. The electronic device typically comprises a processor and input means. Optionally, the electronic device may comprise a memory for storing processed audio and metadata. The electronic device may comprise a communications module operable to download a consumer application. Preferably, the communication module is a wireless telecommunications module. The system may comprise a management server configured to receive user preferences from the electronic device. The system may also be configured to receive an authorisation response from a payment service provider, and, in response to receiving the authorisation response and based on user preferences, to transmit a command or notification to the electronic device to communicate a feedback signal to a user.

The consumer application may comprise at least one of: a user interface; a registration interface; a ‘wallet’ interface of digitised transaction card (e.g. Payment Card) entries; Payment Card identification software; a library of available audio for notification and status; and a preferences interface for making selections.

The electronic device may be arranged to execute the downloaded consumer application to control the electronic device to carry out at least one function, method and/or operation as per the embodiments described herein.

Moreover, the electronic device may be arranged to execute the downloaded consumer application to control the electronic device to perform a set of actions, the set of actions may comprise at least one of: making an NFC transaction using the digital wallet application; playing distinct notification sounds when an NFC transaction has occurred; providing distinct notification vibratory feedback when an NFC transaction has occurred. The set of actions may comprise at least one of: making an online transaction using the digital wallet actions; playing distinct notification sounds when an online transaction has occurred; providing distinct notification vibratory feedback when an online transaction has occurred.

The notification sound or vibration feedback may indicate at least one of: transaction status; the number of transactions made within a time period; value of the transaction; cumulative value of transactions made within a time period; frequency of transactions made within a time period; data relating to a customer reward scheme; and indication of a threshold value being reached in relation to: number of transactions; frequency of transactions; or cumulative value of transactions.

Ideally, the electronic device is arranged to associate with a user account the data extracted from a set of data-bearing media. Advantageously, this enables payment cards and specific audio notifications to be linked to the same user account, and thereby enables payment transaction status information to be relayed to the consumer by those specific audio notifications.

The application may be sourced from an application store and/or content provider. For example, the content provider may comprise the Apple® Appstore®. The content provider may comprise a cloud computing provider.

The input means of the electronic device may comprise user-input apparatus arranged to receive an input from a user. In some embodiments, the user input apparatus may comprise a touch sensitive display screen. Advantageously, this allows a user to input data to the electronic device.

Preferably, the consumer application comprises a graphical user interface (GUI). The graphical user interface may comprise user-interactable artefacts such as buttons.

Preferably, the user-interactable artefacts may be displayed on the screen and receive a user input for selection or control of those artefacts. The electronic device may be controlled to selectively hide those artefacts in dependence on the state of the electronic device.

Preferably, the electronic device is controlled by the consumer application to provide feedback about payment transaction data.

The system may further comprise of at least one of; a management server; and a management database. The management server may comprise at least one of a user registration module; an encryption module; a decryption module; and a Payment Card Provider. The management database may comprise at least one of: a library of audio media for notification alerts; and Payment Card truncated PAN and Token data.

According to another aspect of the invention, there is provided a method for managing transaction metadata, audio data and notification preferences applied to transactions carried out using a digital wallet. The method may comprise performing a transaction using the digital wallet, receiving, at an electronic device acting as the digital wallet or at a management server in communication with the electronic device, a notification that a transaction has been successful, and communicating a feedback signal to a user based on user preferences.

For a better understanding of the invention, and to show how embodiments of the same may be carried into effect, reference will now be made, by way of example only, to the accompanying diagrammatic drawings in which:

FIG. 1A shows a digital wallet application according to an existing implementation;

FIG. 1B shows a schematic view of a system according to an existing implementation;

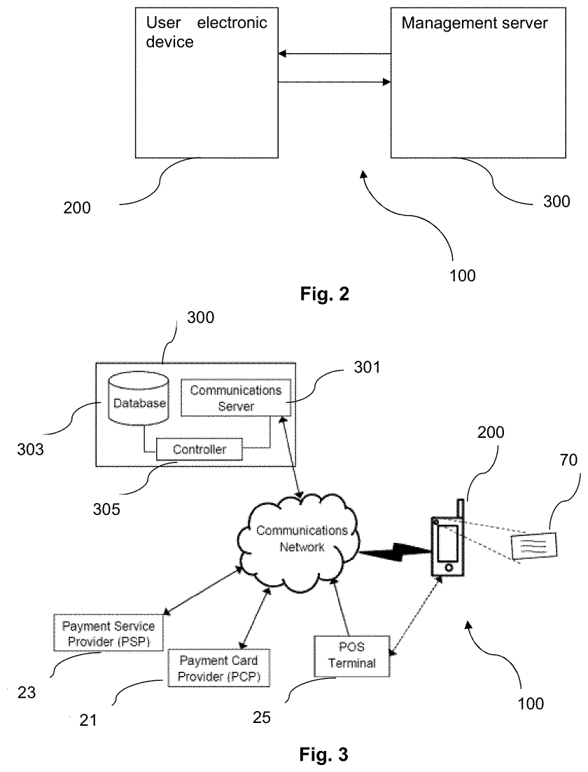

FIG. 2 shows an example system according to aspects of the present invention;

FIG. 3 shows an example system according to aspects of the present invention;

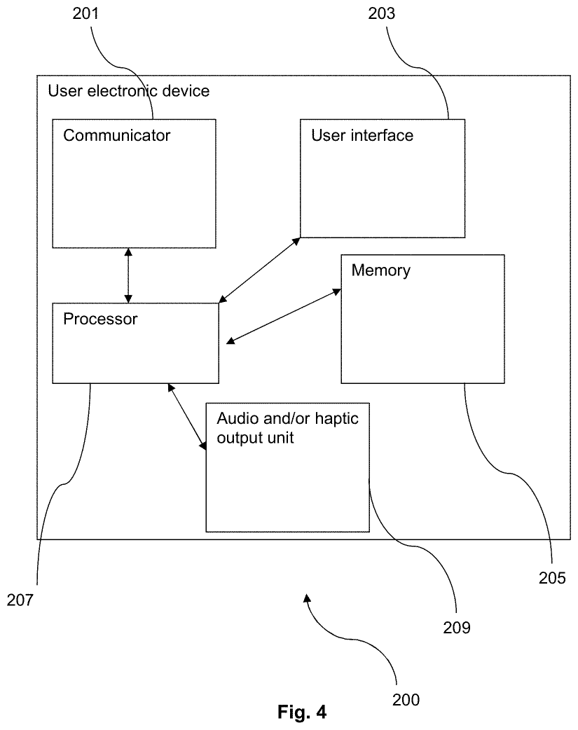

FIG. 4 shows an example user electronic device according to aspects of the present invention;

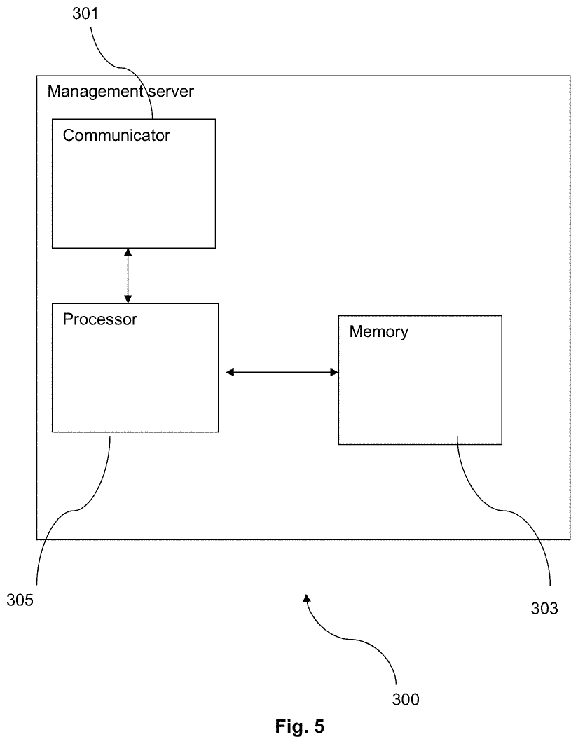

FIG. 5 shows an example management server according to aspects of the present invention;

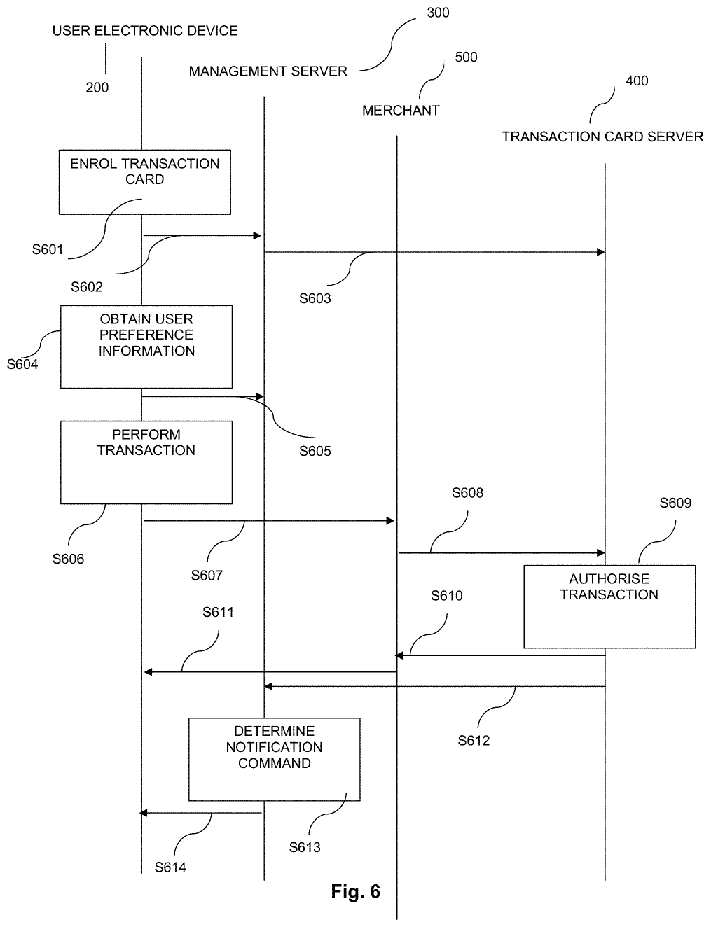

FIG. 6 shows an example signal flow diagram according to aspects of the present invention; and

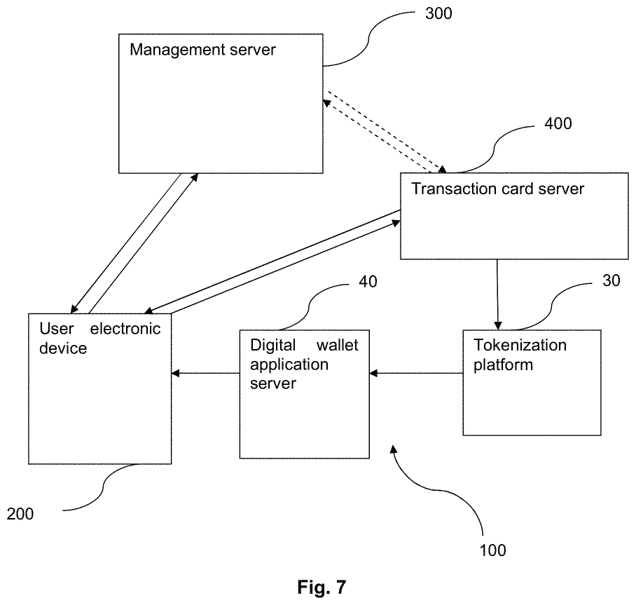

FIG. 7 shows an example system according to aspects of the present invention.

Referring to FIG. 2, there is shown a system 100 according to aspects of the present invention. The system 100 comprises a user electronic device 200 and a management server 300. The user electronic device 200 and management server 300 are communicatively coupled to one another, e.g. via a wireless communication connection, such that they may send and receive data from one another. The system 100 is configured to provide improved and securer point-of-sale feedback to digital wallet users.

The user electronic device 200 acts as a digital wallet. In particular, a digital wallet application and consumer application are both installed on the user electronic device 200, and are operable separately or in combination to output audible and/or haptic feedback according to user preference information. The consumer application is not required in all examples of the present invention as all functionality may be provided by the digital wallet application. The user preference information may be input to the consumer application or the digital wallet application by the user. The digital wallet and consumer applications are downloadable from an application store and/or content provider. For example, the content provider may comprise the Apple® Appstore® or Google® Play®. The consumer application may be incorporated into another application on the device. The functionality of the consumer application may be provided as a software developer's kit (SDK) so that the consumer application may be incorporated into another application such as a banking application.

FIG. 3 illustrates another representation of a system 100 according to the present invention. The system 100 comprises the user electronic device 200 and management server 300 also shown in FIG. 2. The system shown in FIG. 3 uses a communications network, such as a wide-area network, and in particular the Internet for example, which connects the various parties involved in the system and provides network infrastructure for the exchange of data. The user electronic device 200 is connected to the communications network in order to upload data for processing to the management server 300. The consumer application comprises an application interface that is used to gather data from the user, and to display data sent to the application by the management server 300 via a communications network. For example, the consumer application may gather transaction card information by capturing an image of a physical transaction card 70 using the device camera as shown in FIG. 3.

Data input to the consumer application by the user can be uploaded via the communications network to a centralized hub (e.g. the management server 300), where it can be managed and processed. The management server 300 may receive data sent via the communications network and provide data to other components connected to the communications network. The management server 300 comprises a communicator 301 shown in the form of a communications server, a processor/controller 305 and a memory/database 303. Data is received and processed at the management server 300 by the communications server 301, which is operatively coupled with the controller 305. The controller 305, in turn, is operatively coupled with the database 303. Data that is received by management server 300, or data that is of use for the operation of the management server 300, may be stored in the database 303. The management server 300 is external to the consumer application and acts as an on demand service.

Although not shown in FIG. 3, the management server 300 may further comprise an encryption module for encrypting data before it is communicated, a decryption module for decrypting encrypted data communicated to the management server, a user registration module for registering individual users and their associated devices, a user preferences module for processing the preferences selected by a user using the consumer application, and a notification module for generating signals and/or commands to be communicated to the electronic device during a transaction process.

In order to perform transactions, the user electronic device is configured to communicate with a point- of-sale (POS) terminal 25 associated with a particular merchant using NFC or other short-range wireless communication protocol. This communication is depicted by a dotted line in FIG. 3. FIG. 3 further shows at least one transaction card provider (PCP) 21 and at least one transaction card server, which is identified as a payment service provider (PSP) 23. The components are connected via the communications network. The user electronic device is separately or additionally configured to perform transactions online by communicating with a merchant server.

Referring to FIG. 4, there is shown a simplified schematic diagram of an example user electronic device 200 in accordance with the present invention. The user electronic device 200 comprises a communicator 201 , a user interface 203, a memory/data store 205, a processor 207, and audio and/or haptic output unit 209. The memory 205 has stored thereon a digital wallet application. The processor 207 is communicatively coupled to the communicator 201 , user interface 203, memory 205, and audio and/or haptic output unit 209. The audio and/or haptic output unit 209 may comprise a speaker such as a loudspeaker for providing audible feedback (e.g. audible notifications). Additionally or separately, the audio and/or haptic output unit 209 may comprise a vibration unit such as a vibration motor for providing feedback (e.g. notifications) in the form of vibrations.

The user interface 203 may comprise or be associated with a display. The user electronic device 200 may also comprise a camera. The communicator 201 is operable to facilitate exchange of data with other processing elements shown in FIGS. 2 and 3 via the communications network, or with the POS terminal via NFC. The user electronic device 200 may also operate a consumer application stored within the memory/data store 205, and is able to be run on command by the processor 207 in the conventional manner. The user interface 203 of the user electronic device 200 may be integral with a display of the user electronic device 200, and may be a presence sensitive display such as a touch screen in this embodiment. Typically the user electronic device 200 is a smartphone or tablet.

The digital wallet application comprises a digitised transaction card. The digital wallet application may also comprises a graphic asset associated with the digitised transaction card. The digital wallet application, when executed by the user electronic device 200 may be arranged to display the graphic asset associated with the digitised transaction card. For example, the user electronic device 200 may be arranged to display the graphic asset associated with digitised transaction card in the manner shown in FIG. 1A.

An object of the present invention is to provide a notification command to the user electronic device 200 such that the audio and/or haptic output unit 209 of the user electronic device 200 is able to provide, when the digital wallet application is executed, audible and/or haptic feedback according to the notification command.

In an example of this, the processor 207 of the user electronic device 200 obtains user preference information in relation to the digital wallet application. In one example of this, the user electronic device 200 receives a user command for selecting the user preference information. The user command may be provided by user input via the user interface 203 of the user electronic device 200. The user input may be provided via voice control.

The processor 207 of the user electronic device 200 controls the communicator 201 to communicate the user preference information to the management server 300.

The processor 207 of the user electronic device 200 controls the communicator 201 to receive, from the management server 300, a notification command (e.g. for the digital wallet application). The notification command is determined according to the user preference information. The notification command determines the audible and/or haptic feedback to be provided in relation to the digitised transaction card.

The processor 207 of the user electronic device 200 controls the audio and/or haptic output unit 209 to provide, when the digital wallet application is executed, audible and/or haptic feedback according to the notification command received from the management server 300 in response to the digitised transaction card being selected and/or a transaction being performed using the digitised transaction card.

Significantly, the user electronic device 200 provides audible and/or haptic feedback that is specific to the user. The feedback can be provided when the digitised transaction card is selected in the digital wallet application for the purposes of allowing the user to identify the digitised transaction card when visual inspection of the digital wallet application is not possible or not sufficient to identify the digitised transaction card. The feedback can be provided when the transaction is performed using the digitised transaction card so that the user receives and audible and/or haptic confirmation of the transaction. Based on the user preference information, the feedback can include information that is encoded in a user specific way and convey sensitive information to the user in a secure manner. The sensitive information includes the digitised transaction card; the status of the transaction; the value of the transaction; the cumulative value of transactions made during a predetermined time period; the number of transactions made during a predetermined time period; the frequency of transactions made within a predetermined time period; and whether the digitised transaction card is associated with a loyalty scheme.

Referring to FIG. 5, there is shown a simplified schematic diagram of an example management server 300 in accordance with the present invention. The management server 300 comprises a communicator 301 a memory 303 and a processor 305. The communicator 301 is in communication with the communicator 201 (FIG. 4) of the user electronic device 200. The processor 305 is communicatively coupled to the communicator 301 and memory 303.

The processor 305 of the management server 300 controls the communicator 301 to receive the user preference information from the user electronic device 200 (via the communicator 201). The processor 305 controls the communicator 301 to determine a notification command. The notification command is determined according to the user preference information. The processor 305 obtains the notification command, and controls the communicator 301 to communicate the notification command to the user electronic device 200.

The management server 300 may further comprise a user accounts module which is associated with a user accounts database. Together, the processor 305 and user accounts module may be configured to register individual users and their associated devices, to process the preferences selected by a user using the consumer application, to identify the user information initially, to pass the information to the user accounts database and to build a profile of the user based upon preference information.

The memory 303/database/data store of or associated with the management server 300 may comprise a user accounts database. The user accounts database may contain specific information relating to each user such as the digitised transaction cards and/or registered tokens for the digitised transaction cards, a user profile and enrolment information and the user's preference information.

The communicator 301 may also comprise or be associated with an encryption module for encrypting data before it is communicated, a decryption module for decrypting encrypted data communicated to the management server 300, and a notification module for generating signals and/or commands to be communicated to the electronic device.

Referring to FIG. 6, there is shown a signal flow diagram for an example process in accordance with the aspects of the invention. This process is for generating audible and/or haptic feedback in response to the user electronic device performing a transaction with a digitised transaction card.

In step S601 the user of the user electronic device 200 enrols a transaction card. This may have already been performed, and is not required in all examples of the present invention.

If the user has enrolled a transaction card, step S602 is performed which involves identification information for the transaction card being transmitted to a management server 300 which in turn transmits information to the transaction card server 400 in step S603. In some examples, the identification information may be transmitted from the user electronic device 200 directly to the transaction card server 400 rather than via the management server 300. The transaction card server 400 may then provide a reference identifier for the transaction card and a graphic asset for the transaction card may also be transmitted to the user electronic device 200, but this is not essential for the present invention.

In step S604, the user electronic device 200 obtains user preference information.

In step S605, the user preference information is transmitted to the management server 300.

In step S606, the user electronic device 200 performs a transaction using the digital wallet application. The transaction involves communicating transaction card information to a merchant 500 as represented by step S607. The transaction card information may be transmitted via NFC to a payment terminal of the merchant 500 with NFC enabled. The merchant transmits a request to authorise the transaction to the transaction card server 400 in step S608. Of course, the transaction does not need to be performed via NFC, and can additionally or separately be performed online by communicating with a merchant server.

In step S609, the transaction card server 400 authorises the transaction. This may require that the transaction card server 400 communicates with additional entities. An authorisation response is transmitted to the merchant 500 in step S610. An authorisation response is transmitted from the merchant 500 to the user electronic device 200 in step S611. An authorisation response is transmitted from the transaction card server 400 to the management server 300 in step S612.

In step S613, in response to receiving the authorisation response, the management server 300 determines a notification command according to the user preference information received in step S605. The notification command may additionally be determined according to the authorisation response. The authorisation response may indicate whether the transaction was successful, and/or the amount of the transaction, and/or the merchant associated with the transaction. This information may be used along with the user preference information to determine the notification command.

In step S614 the notification command is transmitted to the user electronic device 200. In this way, the user electronic device 200 is able to provide audible and/or haptic feedback according to the notification command received from the management server 300 in response to transaction being performed with the merchant 500.

The example of FIG. 6 relates to providing audible and/or haptic feedback in response to the performance of a transaction. In other examples, such as where the audible and/or haptic feedback is provided in response to a digitised transaction card being selected in the digital wallet application, steps 606 to 612 are not required. Instead, the management server 300 may determine the notification command directly in response to receiving the user preference information and may then communication the notification command to the user electronic device 200.

Referring to FIG. 7, there is shown another example of a system 100 in accordance with the present invention. The system 100 comprises the user electronic device 200, the management server 300, the transaction card server 400, the tokenization platform 30, and the digital wallet application server 40.

A general example operation of the system 100 will now be described.

The initial process of downloading the application, installation on the user electronic device 200 and registration of a user will be described.

The user initially downloads the consumer application to their user electronic device 200 and installs the consumer application to allow the consumer application to interact with and control the user electronic device 200. The consumer application is stored in the device memory/database and may be sourced from an application store and/or content provider. For example, the content provider may comprise the Apple® Appstore® and/or may comprise a cloud computing provider.

After installation of the application, a user may register personal details using the consumer application interface. These details are used for identification purposes and for subsequent authentication requests, The consumer application encrypts and communicates the user details to the management server 300, which receives the details at communicator 301 (FIG. 5) via an application programming interface (API). The communicator 301 then decrypts the details and passes them to the processor 305 (FIG. 5) to allow a user profile to be created in the user accounts database. Although only a single user electronic device 200 is depicted here, it will be appreciated that more than one user electronic device 200 will be able to communicate with the management server 300 via the communications network at any time.

As the management server 300 is an on-demand service, the user electronic device 200 requires a connection to the communications network, such as an Internet connection, for the user to be able to interact fully with the consumer application. Where a user electronic device 200 cannot connect to the management server 300, then the application is still be able to perform much of its functionality with only locally cached media. It is noted however that changes to preferences are not saved to the relevant database and so these changes do not persist in such a situation.

When a connection to the communications network and connection to the management server 300 are established, the details are encrypted using an encryption module (not shown) and persisted in the user accounts database.

The process of enrolment of a user, and the process relating to the user's image preferences will now be described.

Having registered with the service, the user may enrol at least one transaction card used in their existing digital wallet application via the consumer application or directly from the digital wallet application if the consumer application is integrated with the digital wallet application. The consumer application may have the functionality to enrol the transaction card in the digital wallet application simultaneously and automatically.

To enrol the at least one transaction card, the user is typically required to input at least a Primary Account Number (PAN) for the card, and optionally may input an expiry date and security code. The encrypted card information is securely transferred from the device 200 to the tokenization platform 30 via the communications network. The transfer of transaction card data may be via the management server 300, although the management server 300 is typically not able to decrypt the encrypted card information, as this information may only be decrypted by the tokenization platform 30. The transaction card data may be transferred directly from the user electronic device 200 to the tokenization platform 30, or may be transferred via the transaction card server 400. The tokenization platform 30 may be part of or may be associated with the transaction card server 400.

The tokenization platform 30 decrypts the PAN and any other card information from which it generates a card identifier (CID). The PAN and other card information is then stored in a card data vault associated with the tokenization platform 30. The CID is a non-sensitive data equivalent used to refer to the card so that reference can be made to it without any sensitive information being transferred via non-encrypted communications. The tokenization platform 30/transaction card server 400 encrypts and securely returns the CID to the management server 300 and/or the user electronic device 200.

The CID, at least, is subsequently transferred from the consumer application operating on the user electronic device 200 to the management server 300. At this point, the consumer application may communicate additional data such as user-specific data or assets, although it will be appreciated that this information may be communicated to the management server by the electronic device at any time.

The management server 300 confirms to the user electronic device 200 that the data has been received. A confirmation may be communicated to the user.

Once the management server 300 has received the CID at its communicator 301, the user accounts module of the management server 300 is configured to store the CID in the user accounts database for subsequent use.

The card enrolment process is then complete, and the user is prompted to either enrol more cards, in which case the process repeats until the user has finished enrolling transaction cards. A user can set their unique user preferences at any time after payment cards have been enrolled with the consumer application. The preferences are used to determine point-of sale feedback, and in particular, which audible and/or haptic feedback notifications will be generated and under which circumstances they will be performed. More specifically, the user can associate specific response profiles with specific meanings and these can be stored centrally on the management server. For example, the user can associate three different response profiles with three different feedback meanings such as the transaction status, the value of the transaction, and the number of different transactions made, amongst others as described above. The present invention is not limited to three different response profiles and more or fewer response profiles can be provided.

Response profiles can be created within the consumer application using a profile activity. This activity will provide user-selectable patterns of audible and/or haptic feedback that a user can associate with a given feedback (number of transactions, transaction amount threshold etc.)

The user input to the user electronic device 200 may be passed to a preferences module that is in communication with both a preferences database and a notifications module. In particular, the user electronic device 200 may encrypt the user preference information before communicating it to the management server 300, where it is passed from the communicator 301 to the processor 305. The processor 305 utilizes the preference information to update the user's profile in the user accounts database and to access or otherwise determine the relevant notification command that corresponds to the user's preference. If this is successful, the communicator 301 again issues a confirmatory response to the electronic device.

The management server 300 communicates updates to the user preference information and other metadata associated with the digitised transaction card to the transaction card server 400. The management server 300 is also configured to communicate with the consumer application to ensure that the correct notification files, such as sound files or vibration feedback signals are stored on the user electronic device 200 to enable quick recall when required. The sound files may be stored as WAV files for example. This means that the different audio and/or haptic feedbacks are pre-stored as files on the user electronic device 200, and when a particular notification command is received from the management server 300, the processor of the user electronic device 200 obtains the required file to generate the feedback according to the notification command.

The consumer application may also communicate with the transaction card server 400 to update metadata associated with the digitised transaction card so that when a transaction is made using that card, a chain of authorisation requests between the user electronic device 200, merchant 500, and transaction card server 400 takes place. In addition to these, the transaction card server 400 also communicates an authorisation response to the management server 300. This response is then communicated to the consumer application via the communications network to allow POS feedback to be implemented according to the user's indicated preferences. The communication of this authorisation response to the management server 300 allows the management server 300 to provide a custom notification to the user as opposed to the standard, non-customisable and non-specific feedback provided by the digital wallet application. Advantageously, the provision of a separate management server 300 to enact these notifications ensures that both the transaction made using the user electronic device 200 and the notification provided by the consumer application are as swift as possible and that there is no uncertainty about the information that has been communicated both ways.

The user preferences include the default transaction notification sound and default transaction vibration feedback associated with the digitised transaction card and the rules for generating notifications. For example, when a user uses the digital wallet application to make a number of transactions over a predetermined time period, a particular notification may be used when the user makes the ‘Nth’ transaction and thereby reaches a threshold transaction. This threshold may be set by the merchant to identify when the user qualifies for a loyalty reward, or by the transaction card server or another entity to reward the customer for spending using their card or platform. In these examples, the threshold and cumulative transaction value would be calculated and compared by the management server following each transaction.

Separately or additionally, the user may predefine a transaction limit threshold and a specific notification that corresponds to an exceedance of this threshold. Such examples are beneficial in enabling a user to easily manage their finances.

Separately or additionally the notification may relate to an authorisation result. That is, the feedback may convey whether the transaction was successful.

In some embodiments, the frequency of transactions made within a particular predetermined time period may result in a specific notification, or the number of transactions made during that period may be associated with a notification. The notification may be particular to a specific merchant, transaction card server, other entity, or may be related to a transaction status.

In some embodiments the consumer application may ‘gamify’ the data, requiring the user to make specific transactions for a specific notification to be played or accessible.

It will be appreciated that multiple feedback notifications may be enacted simultaneously or consecutively if a number of rules or preferences have been set. That is a combination of multiple different audible and/or haptic outputs may be generated according to a notification command.

In some embodiments, once the user has set their user preferences, the user electronic device 200 may download notification data selected by the user from the management server 300 and store it in the user electronic device 200 memory for recall later. If the user preferences change, the notification data is replaced with new data. The notifications module is configured to prompt the device to access the data and communicate this following a transaction.

In some embodiments, the audible and/or haptic feedback may also be associated with an image displayed on the device display when a transaction has occurred.

In some embodiments, the audible and/or haptic feedback may be made by the consumer application. In some embodiments, the audible and/or haptic feedback may be made by the digital wallet application rather than the consumer application. In this case, the digital wallet may access the notification directly from the management server memory/database and stores it in the user electronic device 200 memory.

In summary, there is provided a system, device and method for executing a digital wallet application. The system comprises a user electronic device. A processor of the device executes a digital wallet application associated with at least one digitised transaction card. The device obtains user preference information in relation to the digital wallet application; communicates the user preference information to a management server; receives, from the management server, a notification command. The notification command is determined according to the user preference information, and determines the audible and/or haptic feedback to be provided in relation to the digitised transaction card. The user electronic device controls an audio and/or haptic output unit of the device to provide, when the digital wallet application is executed, audible and/or haptic feedback according to the notification command in response to the digitised transaction card being selected and/or used for a transaction.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Although a few preferred embodiments of the present invention have been shown and described, it will be appreciated by those skilled in the art that various changes and modifications might be made without departing from the scope of the invention, as defined in the appended claims.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed

1. A system comprising:
a user electronic device comprising a communicator, an audio and/or haptic output unit, and a processor communicatively coupled to the communicator and the audio and/or haptic output unit, wherein the processor is operable to execute a digital wallet application, wherein the digital wallet application is associated with at least one digitised transaction card, and wherein the processor of the user electronic device is operable to:
obtain user preference information in relation to the digital wallet application;
control the communicator to communicate the user preference information to a management server;
control the communicator to receive, from the management server, a notification command for the digital wallet application, the notification command being determined according to the user preference information, and the notification command determining the audible and/or haptic feedback to be provided in relation to the digitised transaction card, and
control the audio and/or haptic output unit to provide, when the digital wallet application is executed, audible and/or haptic feedback according to the notification command received from the management server in response to the digitised transaction card being selected and/or a transaction being performed using the digitised transaction card.

2. The system of claim 1, wherein the digital wallet application is associated with a plurality of digitised transaction cards, and wherein notification commands are received for each of the digitised transaction cards according to the user preference information, and wherein different audible and/or haptic feedback is provided depending on which digitised transaction card is selected and/or used to perform a transaction.

3. The system of claim 2, wherein the digital wallet application, when executed, is arranged to display a plurality of graphic assets each associated with a different one of the digitised transaction cards, and in response to one of the digitised transaction cards being selected by the user, the processor of the user electronic device is operable to control the audio and/or haptic output unit to provide audible and/or haptic feedback according to the notification command associated with the selected digitised transaction card.

4. The system of claim 1, wherein the audio and/or haptic output unit comprises a vibration unit configured to vibrate the user electronic device, and wherein at least one of the frequency, amplitude and duration of the vibration is determined by the notification command.

5. The system of claim 1, wherein the audio and/or haptic output unit comprises a speaker configured to output an audible signal, and wherein at least one of the frequency, amplitude and duration of the audible signal is determined by the notification command.

6. The system of claim 1, wherein the user electronic device comprises a user input for receiving the user preference information.

7. The system of claim 1, wherein the audible and/or haptic feedback provided according to the notification command changes based on at least one of:
the digitised transaction card;
the status of the transaction;
the value of the transaction;
the cumulative value of transactions made during a predetermined time period;
the number of transactions made during a predetermined time period;
the frequency of transactions made within a predetermined time period; and
whether the digitised transaction card is associated with a loyalty scheme.

8. The system of claim 1, wherein the audible and/or haptic feedback provided according to the notification command changes based on whether a predetermined threshold value has been exceeded in relation to at least one of:
the cumulative value of transactions;
the number of transactions; and
the frequency of transactions.

9. The system of claim 1, wherein the user electronic device is operable to control the communicator to communicate transaction information to a transaction card server in response to a transaction being performed by the digitised transaction card associated with the digital wallet application, wherein the transaction card server is arranged to authorise the transaction in response to receiving the transaction information.

10. A system as claimed in The system of claim 9, wherein the transaction card server is arranged to communicate an authorisation response to the management server, the authorisation response identifying at least the digitised transaction card that performed the transaction, and wherein the management server is arranged to communicate the notification command to the user electronic device based on the authorisation response received from the transaction card server and the user preference information received from the user electronic device.

11. The system of claim 1, wherein the notification command comprises an audio file and/or haptic file, and wherein the processor of the user electronic device is operable to store the audio file and/or haptic file in a memory of the user electronic device for subsequent use by the audio and/or haptic output unit.

12. The system of claim 1, wherein the processor of the user electronic device is operable to control the communicator to communicate the user preference information to the management server and an identifier for the digitised transaction card associated with the user preference information.

13. A method performed by a system comprising a user electronic device, the user electronic device comprising a communicator, an audio and/or haptic output unit, and a processor communicatively coupled to the communicator and the audio and/or haptic output unit, wherein the processor is operable to execute a digital wallet application, the digital wallet application is associated with at least one digitised transaction card, and wherein the method comprises:
obtaining user preference information in relation to the digital wallet application;
controlling the communicator to communicate the user preference information to a management server;
controlling the communicator to receive, from the management server, a notification command, the notification command being determined according to the user preference information, and the notification command determining the audible and/or haptic feedback to be provided in relation to the digitised transaction card; and
controlling the audio and/or haptic output unit to provide, when the digital wallet application is executed, audible and/or haptic feedback according to the notification command received from the management server in response to the digitised transaction card being selected and/or a transaction being performed using the digitised transaction card.

14. A user electronic device suitable for use with the system of claim 1, the user electronic device comprising a communicator, an audio and/or haptic output unit, and a processor communicatively coupled to the communicator and the audio and/or haptic output unit, wherein the processor is operable to execute a digital wallet application, the digital wallet application is associated with at least one digitised transaction card, and wherein the processor of the user electronic device is operable to:
obtain user preference information in relation to the digital wallet application;
control the communicator to communicate the user preference information to a management server;
control the communicator to receive, from the management server, a notification command, the notification command being determined according to the user preference information, and the notification command determining the audible and/or haptic feedback to be provided in relation to the digitised transaction card; and
control the audio and/or haptic output unit to provide, when the digital wallet application is executed, audible and/or haptic feedback according to the notification command received from the management server in response to the digitised transaction card being selected and/or a transaction being performed using the digitised transaction card.

15. A management server suitable for use with the system claim 1, the management server comprising a communicator and a processor communicatively coupled to the communicator, wherein the communicator of the management server is operable to:
receive user preference information from a user electronic device, and wherein the processor of the management server is operable to:
determine a notification command according to the received user preference information, the notification command determining the audible and/or haptic feedback to be provided by the user electronic device in relation to a digitised transaction card associated with the digital wallet application; and
communicate the notification command to the user electronic so that the user electronic device is operable to provide audible and/or haptic feedback according to the notification command.
